(19) United States
(12) Patent Application Publication
(10) Pub. No.: US 2026/0245320 A1
(43) Pub. Date: Aug. 20, 2026

(54) MATERIAL SELECTION AND SEGMENTATION OF 3D OBJECTS

(71) Applicant: Adobe Inc., San Jose, CA (US)

(72) Inventors: Michael Fischer, London (GB); Valentin Mathieu Deschaintre, London (GB); Vladimir Kim, Seattle, WA (US); Thibault Groueix, San Francisco, CA (US); Iliyan Atanasov Georgiev, London (GB)

(73) Assignee: Adobe Inc., San Jose, CA (US)

(21) Appl. No.: 19/056,149

(22) Filed: Feb. 18, 2025

(51) Int. Cl. G06T 19/20; G06F 30/12; G06F 30/27; G06F 119/18

(52) U.S. Cl. CPC G06T 19/20; G06F 30/12; G06F 30/27; G06F 2119/18; G06T 2219/2016

(57) ABSTRACT

Techniques related to material glint generation for digital content are described. In an example, a processing device is operable to output a user interface that previews an object model and receive a material selection that designates a material part of the object model. The processing device is further operable to obtain a plurality of sample images showing different views of the object model and the material part designated by the material selection, input the sample images and the material selection into a material selector model that creates a similarity point cloud enabling material similarity querying across multiple material parts of the object model, and presents, via the user interface, an indication of different material parts of the object model that have a similar material as the material part designated by the material selection.

### BACKGROUND

Modeling tools enable artists and designers to manipulate object models representing 3D objects. Digital content is produced with object models by selecting and modifying characteristics of the 3D objects through a user interface to change appearance of surface materials that shape the 3D objects. Conventional approaches to 3D object material selection and segmentation are challenged with maintaining consistency across multiple viewpoints of the object, potentially resulting in inaccurate or inconsistent surface materials depictions in digital content depicting different object views. Manual corrections to drag, drop, draw, and correct material appearances are tedious and time-consuming, impacting productivity and consuming resources. Additionally, conventional implementations are limited to specific types of object models and incompatible with advanced object model types developed to improve performance and realism.

### SUMMARY

Techniques for material selection and segmentation of 3D objects are described. A modeling tool (e.g., of a content processing system) receives input as a material selection designating a material part of an object model. The system obtains multiple sample images showing different views of the object model and the designated material part. A material selector model of the modeling tool processes the sample images and material selection to generate similarity maps (e.g., heat map images) indicating material similarity across the object model. The similarity maps are used to create a similarity point cloud representing material similarities in three-dimensional space. The system queries the point cloud to identify regions with similar materials and presents an indication of different material parts having a similar material as the designated part. The system processes the analyzed data to produce a rendered image showing the results of the material selection and segmentation process. The rendered image displays the processed object model with the selected materials highlighted or segmented according to the input material selection.

The approach enables efficient and consistent material selection in three dimensions, addressing limitations of two-dimensional methods, and additionally facilitating visualization from novel viewpoints. The material selector model is trained on diverse 3D objects, learning to generate consistent similarity maps across multiple views. The material selector model utilizes video processing techniques to achieve multi-view consistency across a variety of 3D object model types including Neural Radiance Fields, three-dimensional Gaussians, and meshes, providing a versatile solution for three-dimensional modeling and editing systems. Material properties are user editable through the material selector model to generate modified versions of the 3D object, enhancing workflows for digital content creation and editing.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description includes references to the accompanying figures. Entities represented in the figures are indicative of one or more entities and thus reference is made interchangeably to single or plural forms of the entities in the discussion.

FIG. 1 illustrates a block diagram of an example environment for material selection and segmentation of 3D objects, according to aspects of the present disclosure.

FIG. 2a depicts a block diagram of an example modeling system for material selection and segmentation of 3D objects, according to aspects of the present disclosure.

FIG. 2b depicts a block diagram of an example material selector system for processing and analyzing materials in 3D objects, according to aspects of the present disclosure.

FIG. 3 illustrates example results from an example material selector model in response to using different material selection modalities, according to aspects of the present disclosure.

FIG. 4 demonstrates additional example results from an example material selector model based on duplicating sample images, according to aspects of the present disclosure.

FIG. 5 shows example results from an example material selector model in response to complex object model inputs, according to aspects of the present disclosure.

FIG. 6 depicts additional example results from an example material selector model in response to complex mesh inputs, according to aspects of the present disclosure.

FIG. 7 illustrates a flowchart of a process for training an example material selector model, according to aspects of the present disclosure.

FIG. 8 illustrates a flowchart of a process for material selection and segmentation of 3D objects, according to aspects of the present disclosure.

FIG. 9 illustrates a flowchart depicting an algorithm as a step-by-step process for training a machine-learning model according to aspects of the present disclosure.

FIG. 10 illustrates an example of a U-Net architecture according to aspects of the present disclosure.

FIG. 11 shows an example system including various components of an example device usable as any type of computing device as described and/or utilized with reference to FIGS. 1-10 to implement examples of the techniques described herein.

### DETAILED DESCRIPTION

### Overview

3D modeling tools enable artists and designers to manipulate object models representing 3D objects by selecting and modifying specific surface materials. Modeling tools implement user interfaces to designate material parts of an object model and apply changes across different views of the 3D object. Some tools utilize geometric features or semantic information to identify and group similar material, while others adapt material selection techniques from 2D image processing for implementing similar 3D functions with limited effectiveness within 3D space.

Material selection and segmentation techniques face challenges in maintaining consistency across multiple viewpoints of a 3D object. Inaccurate or inconsistent material adjustments can occur when rendering previews by changing between different views. Applying manual corrections to address inaccuracies or inconsistencies can be time-consuming. Additionally, some modeling tools rely on proprietary model technology or are compatible with specific types of models, which limits versatility across different asset types and modeling environments. For example, methods optimized for mesh-based models do not work effectively with volumetric representations like Neural Radiance Fields (NeRFs) or point-based models like 3D Gaussians. As object model types evolve to encode improved realism in compact data structures, modeling tools tailored for specific types of 3D models or representations become outdated.

Limitations in conventional solutions can affect productivity and creative workflows in 3D content creation. The lack of robust, multi-view consistent material selection tools hinders efficient editing and refinement of complex 3D assets, particularly object models generated by artificial intelligence (AI) models using generative machine learning techniques, object models obtained through 3D scanning techniques, or object models created from other complex asset analysis. Furthermore, the inability to seamlessly work across various types of 3D representations restricts artists and designers from fully leveraging the advantages of different advanced modeling technologies within a single project. The growing complexity and diversity of 3D assets is outpacing the integration of advancing asset technology with versatile and efficient material selection and segmentation techniques.

An example system implements material selection and segmentation techniques for 3D objects. The system enables efficient and consistent material selection in three-dimensional modeling for rendering images, videos, and other digital content. The system integrates at least one machine learning model trained to integrate multi-view consistency and 3D similarity point clouds for material selection when processing three-dimensional assets, such as object models. Unlike conventional 2D approaches that struggle at achieving consistency across different viewpoints, the machine learning approach adopted by the system generates outputs indicating material selections that are consistent in 3D space and compatible with various 3D modeling formats. The components of the content processing system are trainable and retrainable to accurately model material similarities observed across different views of 3D objects.

In an example implementation, the content processing system receives a material selection designating a material part of an object model and obtains multiple sample images showing different views of the object model and the designated material part. The system executes a material selector model that is trained using machine learning to process the sample images and material selection to generate similarity maps indicating material similarity across the object model. By processing multiple views, the material selector model captures the nuanced material properties across different perspectives of the 3D object.

The material selector model is configured to transform the material selection into a similarity point cloud representative of similarity maps generated from the sample images of the object model. The material selector model operates in 2D space, creating 2D similarity maps that are then back-projected to 3D space via inverse camera projection. The similarity point cloud stores queryable data to identify similar material parts of the object model, e.g., based on similar material surface attributes and properties.

The system processes the analyzed data to produce a rendered image showing the results of the material selection and segmentation process. The rendered image displays the processed object model with the selected materials highlighted or segmented according to the input material selection. An output from the system enables more efficient and accurate material editing in 3D objects, addressing the limitations of conventional 2D approaches that may not fully account for multi-view consistency and 3D spatial relationships.

The material selector model is trained on diverse 3D objects, learning to generate consistent similarity maps across multiple views. The model utilizes video processing techniques to achieve multi-view consistency and is compatible with various three-dimensional representations including Neural Radiance Fields, three-dimensional Gaussians, and meshes. This multi-format compatibility configures the system to handle a wide range of 3D object types, resulting in more versatile and accurate material selection and segmentation. When trained, the system is configured to maintain consistency across different viewpoints, which during inference, is used to improve the accuracy of material selection. The trained system generates realistic material selections for applications in various fields including 3D modeling, content creation, and virtual reality. The material selections produced by the system have improved consistency and accuracy compared to conventional approaches, by successfully capturing specific material attributes across diverse viewpoints and 3D object representations.

Further discussion of these and other examples and advantages are included in the following sections and shown using corresponding figures. In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Digital Content Production Environment

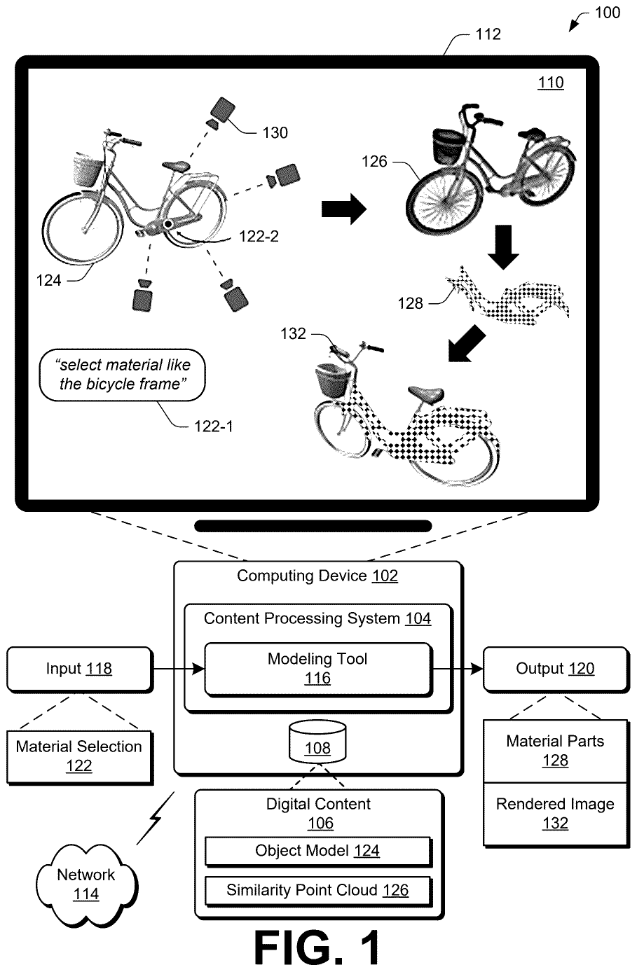

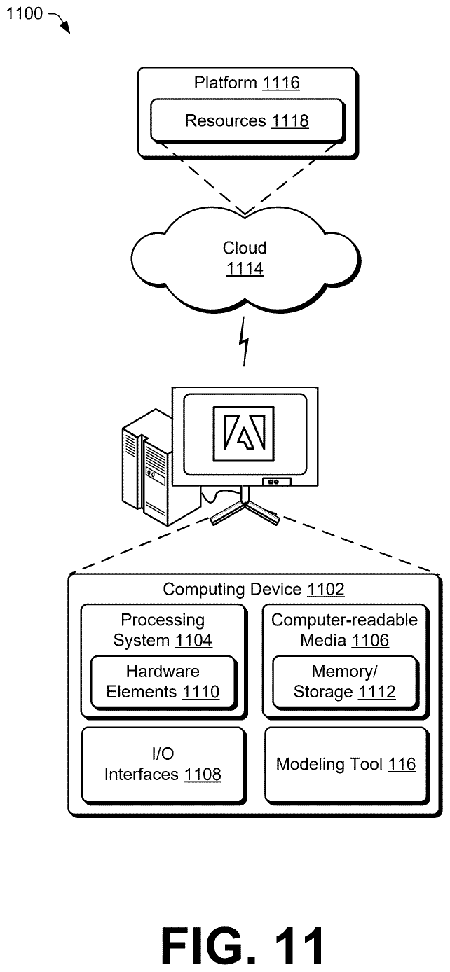

FIG. 1 illustrates an environment 100 for material selection and segmentation of 3D objects. The environment 100 includes a computing device 102, which is configurable in a variety of ways. The computing device 102, for instance, is configurable as a processing device such as a desktop computer, a laptop computer, a mobile device (e.g., assuming a handheld configuration such as a tablet or mobile phone), and so forth. Thus, the computing device 102 ranges from full resource devices with substantial memory components and processor resources (e.g., personal computers, game consoles) to a low-resource device with limited memory and/or processing resources, e.g., mobile devices. Additionally, although a single computing device 102 is shown, the computing device 102 is also representative of a plurality of different devices (e.g., a computing system), such as multiple servers utilized by a business to perform operations “over the cloud” as described in FIG. 11.

The computing device 102 is illustrated as including a content processing system 104. The content processing system 104 is implemented at least partially in hardware of the computing device 102 to process and transform digital content 106, which is illustrated as being maintained in data storage 108 of the computing device 102. Such processing includes creation of the digital content 106, such as for authoring (e.g., editing, modifying) object models, which includes in variations output of similarity point clouds. Other examples of such processing include modification of the digital content 106, and production of the digital content 106 for presentation in a user interface 110, e.g., generating renderable data for output by a display device 112.

The computing device 102 is depicted as being connected to a network 114, which enables communication with other devices or systems. The network 114 enables the computing device 102 to access additional resources or data to support functionality of the content processing system 104. Although illustrated as implemented locally at the computing device 102, functionality of the content processing system 104 is also configurable in whole or in part through functionality available via the network 114, such as part of a web service or in the cloud.

An example of functionality incorporated by the content processing system 104 for processing the digital content 106 is illustrated as a modeling tool 116. The modeling tool 116 is configured to execute complex data processing tasks by receiving input 118 and generating output 120. The modeling tool 116 analyzes the input 118 to perform material selection and segmentation of 3D objects. Trained to recognize patterns and relationships between materials and object parts, the modeling tool 116 determines realistic material selections, enabling the content processing system 104 to generate material selections for modeling or producing realistic renderings of 3D objects.

The input 118 to the modeling tool 116 is depicted as a material selection 122, which can include a prompt selection 122-1 or a UI selection 122-2. The material selection 122 designates a material part of an object model 124. The prompt selection 122-1 refers to a text-based input (e.g., typed text, transcribed spoken text, optical recognition text) describing a specific material to be selected, for example, “select material like the bicycle frame.” The UI selection 122-2 refers to a user interface interaction such as clicking or drawing on the 3D model (e.g., by touching, tapping, mouse-directing, or navigating to a selection region of the user interface 110) to indicate areas for material selection, for example, clicking on a bicycle frame surface to select all similar metal parts.

The modeling tool 116 obtains sample images 130 showing different views of the object model 124 and the designated material part based on the material selection 122. For example, the object model 124 may represent a 3D model of a bicycle as depicted in FIG. 1, a car, a furniture piece, an architectural structure, or other physical object. The object model 124 is representable in various 3D formats such as polygon meshes, NURBS (Non-Uniform Rational B-Splines) surfaces, voxel grids, or implicit representations. The object model 124 is received via the input 118 in some examples, and in variations, the object model 124 is loaded from the data storage 108 (e.g., having been generated during a previous user session with the content processing system 104, having been obtained through the network 114, and so forth). The sample images 130 include multiple 2D renderings or photographs of the object model 124 from various angles and perspectives to capture different material regions. For example, the modeling tool 116 executes a function that generates a series of the sample images 130 that at each iteration or with each sample image, a view of the 3D object is shown from a progressively changing distance and viewing angle. If the material selection 122 designates the metal frame of a bicycle model, the sample images 130 show views around various sides of the bicycle model to highlight visual characteristics of the frame from different vantage points.

The output 120 generated by the modeling tool 116 includes a similarity point cloud 126 and material parts 128. The similarity point cloud 126 represents material similarities between the sample images 130 when projected in three-dimensional space, enabling efficient querying and visualization of material relationships across the entire object model 124. The material parts 128 represent the different regions of the object model 124 that have been identified as having similar materials to the designated part, providing a segmented representation of the object model 124 based on material properties, which can be useful for further editing or analysis tasks.

The combination of the similarity point cloud 126 and material parts 128 enables both quantitative similarity analysis and qualitative segmentation of materials within the 3D object. The modeling tool 116 measures how similar different parts of the object are in terms of their material properties while also grouping parts into distinct segments based on the similarities. This approach allows the modeling tool 116 to perform material selection and segmentation while maintaining spatial relationships and enabling efficient processing of complex 3D objects.

The user interface 110 enables users to interact with the content processing system 104, view the object model 124 and material parts 128, and provide feedback. FIG. 1 shows the user interface 110 presenting the initial object model 124 (e.g., a bicycle) with sample images 130, demonstrating how multiple views are used to capture the object's materials. The user interface 110 presents the material selection 122 alongside visual representations of the object model 124 and material parts 128. Users can manipulate the object model 124 and material parts 128 using various controls, with UI selection 122-2 points indicating user interaction for material selection, while the prompt selection 122-1 shows an alternative text-based input modality.

The input 118 instructs the content processing system 104 to generate a rendered image 132. A rendering module within the modeling tool 116 processes the similarity point cloud 126 and material parts 128 into rendered images. The similarity point cloud 126 is depicted as a distinct element within the digital content 106, visually representing how material similarities are mapped in 3D space. The object model 124 is input to the rendering module of the modeling tool 116, which produces an image of the object with selected materials highlighted or segmented. The final rendered image 132 displays the result of the material selection process, with identified material parts 128 highlighted on the bicycle model.

The modeling tool 116, through a rendering module described below with respect to the additional figures, dynamically updates the user interface 110 to reflect changes in real-time as new material selections are made, providing immediate visual feedback to the user. This interactive rendering process enhances the user experience by allowing rapid iteration and refinement of material selections. The modeling tool 116 is configured to utilize the rendering module to transform the underlying 3D data and material selections into visually meaningful representations for display in the user interface.

To evaluate the quality and accuracy of the generated material selections, the modeling tool 116 implements various metrics, such as consistency across different viewpoints and accuracy of segmentation. By utilizing the modeling tool 116, the content processing system 104 continuously assesses and enhances material selection, addressing the complexities of identifying and segmenting materials in 3D objects and overcoming challenges in creating realistic renderings through automated assistance in material selection and segmentation.

The environment 100 implements a solution for material selection and segmentation of 3D objects by leveraging the modeling tool 116 to process input 118 and produce high-quality renderings with corresponding material selections. The content processing system 104 accepts and processes the material selection 122 to create the similarity point cloud 126 and material parts 128 and generates the rendered image 132 to provide a visual representation of the material selection and segmentation.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Example Architecture of Material Selector Model

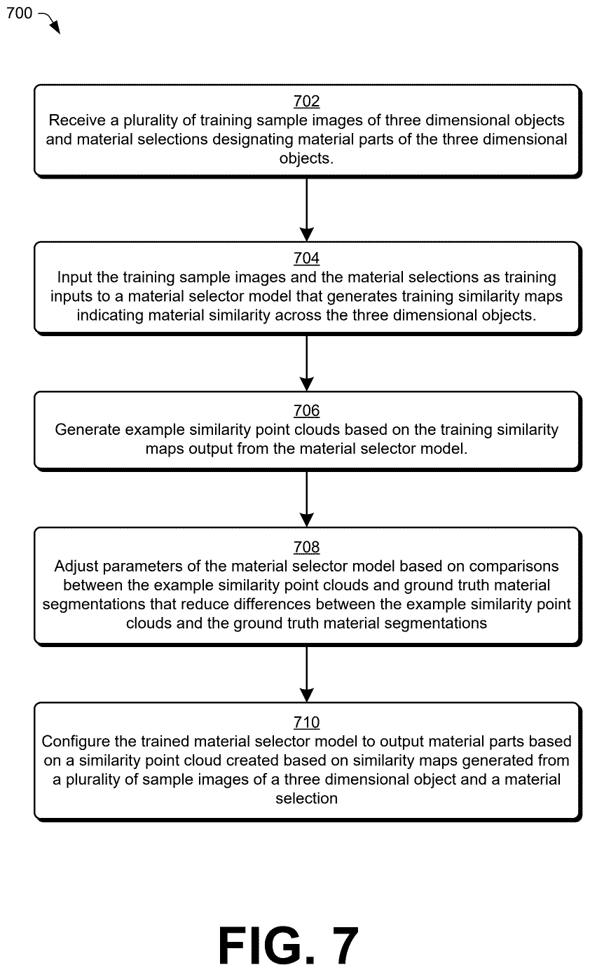

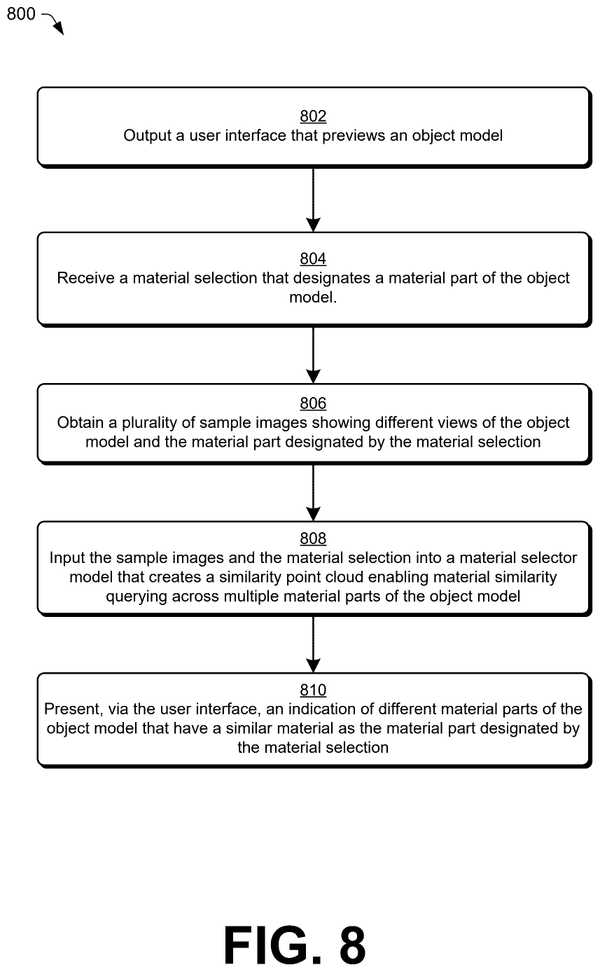

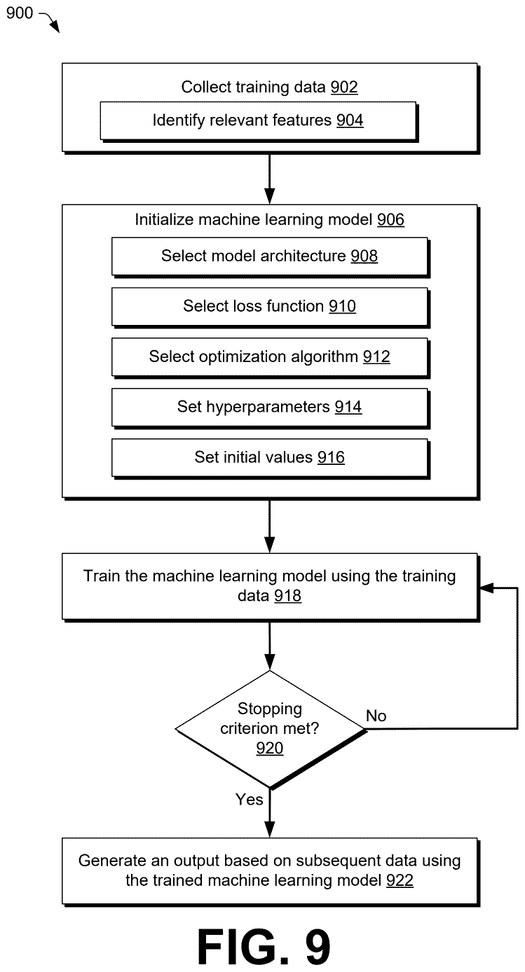

The following discussion describes material selection and segmentation of 3D objects techniques that are implementable utilizing the previously described systems and devices. Aspects of each of the processes, e.g., as shown in FIG. 7, FIGS. 8, and 9, are implemented in hardware, firmware, software, or a combination thereof. The processes are shown as a set of blocks that specify operations performed by one or more devices and are not limited to the orders shown for performing the operations by the respective blocks.

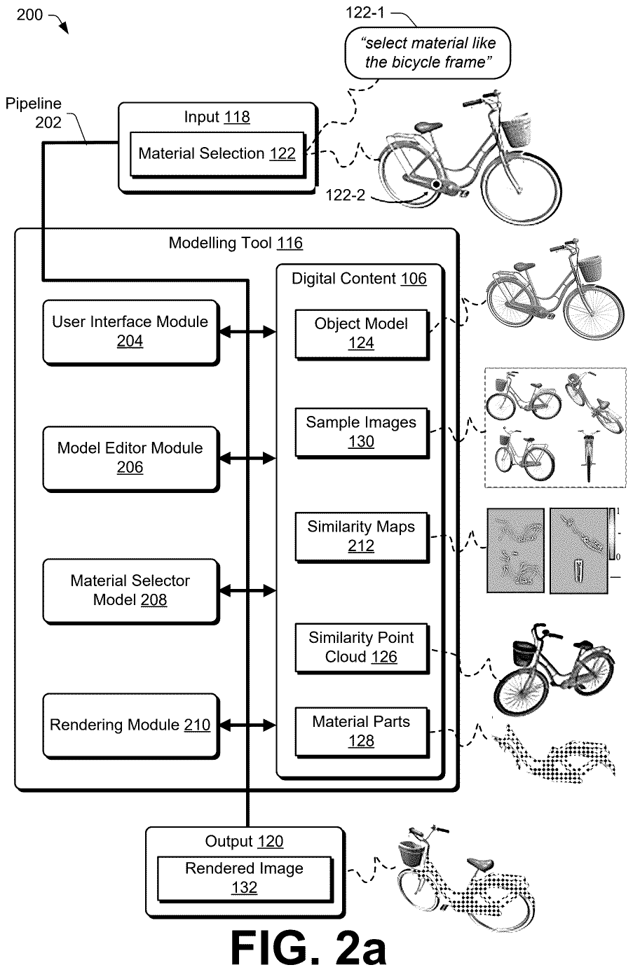

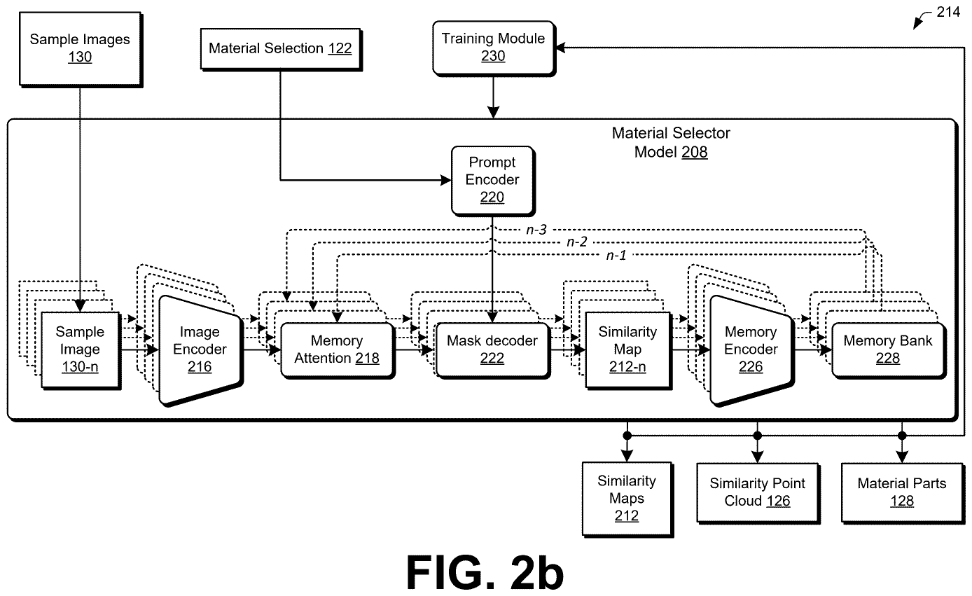

FIG. 2a depicts a block diagram of an example modeling system 200 for material selection and segmentation of 3D objects, according to aspects of the present disclosure. The system 200 illustrates an implementation of the modeling tool 116 within the content processing system 104, shown in greater detail than in FIG. 1.

The modeling system 200 includes a processing pipeline 202 that processes input 118 and generates output 120, demonstrating an example workflow for editing surface appearances of 3D models. In one example scenario, a user of the computing device 102 interacts with the modeling tool 116 to select an object model, such as a bicycle model represented by the object model 124. The user then initiates the material selection process by inputting a prompt selection 122-1 (e.g., typing “select metallic frame material”) or a UI selection 122-2 (e.g., clicking directly on the bicycle frame in the 3D view). The modeling tool 116 receives this material selection 122 as part of the input 118.

The system 200 includes a user interface module 204 that facilitates this interaction as part of managing interactions with the user interface 110 and the system 200, including implementing features that enable manipulation of the object model 124 and observation of the sample images 130. The user interface module 204 converts user interface selections to prompt selections. Specifically, when a user makes a UI selection 122-2 by interacting with the object model 124 displayed in the user interface 110, the user interface module 204 translates this visual selection into a text-based prompt selection 122-1. If a user clicks on the frame of a bicycle model, for instance, the user interface module 204 may generate a prompt selection 122-1 such as “select metallic frame material”. This conversion enables the system to process both direct visual selections and text-based prompts uniformly, enhancing flexibility and user interaction options.

The sample images 130 are received as part of the input 118 in at least one example, and the sample images 130 are generated by the system 200 in response to the input 118 in at least one other example. The system 200 combines the sample images 130 received by the input 118 with the sample images 130 generated by the system 200 in other examples. In the illustrated example, the sample images 130 capture material data of the bicycle model from multiple perspectives (e.g., at various angles and under different lighting conditions) to facilitate comprehensive material analysis.

Upon receiving the input 118, the model editor module 206 prepares the object model 124 and the sample images 130 for processing. If produced internally, the sample images 130 are captured in response to the input 118 by causing the system 200 to render different views of the object model 124 associated with the material selection 122. For example, the model editor module 206 automatically adjusts orientation or isolates specific parts of the object model 124 based on the material selection 122, and with each adjustment, causes a rendering module 210 of the modeling tool 116 to output one of the sample images 130.

A material selector model 208 of the modeling tool 116 is configured to transform the material selection 122 into a similarity point cloud 126 representative of similarity maps 212 generated from the sample images 130 of the object model 124. The similarity point cloud 126 stores quarriable data to identify similar material parts of the object model 124, e.g., based on similar material surface attributes and properties.

The material selector model 208, which is shown with greater detail in FIG. 2b, implements machine learning techniques to analyze the input 118. The material selector model 208 utilizes convolutional neural networks (CNNs) and transformer architectures to process the sample images 130 and extract relevant features for material similarity analysis. The material selector model 208 is trained on a diverse dataset of 3D objects with annotated material properties, including textures, reflectance characteristics, and physical attributes. During training, the material selector model 208 learns to recognize patterns and relationships between visual appearance and underlying material properties across various object types, such as furniture, vehicles, and architectural elements. The training process involves techniques like data augmentation, transfer learning from pre-trained vision models, and multi-task learning to improve generalization. The architecture of material selector model 208 is detailed in FIG. 2b and incorporates attention mechanisms and memory modules to maintain consistency across multiple views of 3D objects. Through iterative refinement and backpropagation, the material selector model 208 is trained or learns to generate similarity maps 212 that accurately capture material properties consistently across different object types and viewing angles.

For each sample image 130, the material selector model 208 generates a corresponding similarity map 212. These similarity maps 212 indicate the likelihood of each pixel or region of the sample images 130 sharing material properties with the selected area and are created through a multi-step process. First, visual features are extracted from the sample image 130, such as color, texture, and local patterns. The extracted visual features are then compared to a characteristics of a selected area using convolutional neural network layers. The comparison generates per-pixel similarity scores, which are normalized to comparable values (e.g., between 0 and 1). For example, areas with higher scores indicate greater likelihood of sharing material properties with the selected region. The scores are refinable, considering spatial relationships and global context. Memory attention enables the material selector model 208 to incorporate information from previously processed sample images 130 to ensure consistency across multiple perspectives of the 3D object. The resulting similarity maps 212 provides detailed representations of material similarity across each sample image.

The material selector model 208 then aggregates these similarity maps 212 to create a similarity point cloud 126. This point cloud represents material similarities in three-dimensional space, enabling efficient querying and visualization of material relationships across the entire object model 124.

The similarity point cloud 126 is created by back-projecting the 2D similarity maps 212 into 3D space, considering the geometry and perspective of the object model 124. A back-projection algorithm uses depth information from each sample image 130 to map 2D pixel coordinates to 3D world coordinates. For each pixel in a similarity map 212, that pixel 3D position is calculated using camera parameters and depth data, and the similarity value is assigned to that pixel 3D position. This process is repeated across multiple sample images 130. Surface normals and occlusion relationships are considered to incorporate geometry information. Camera matrices for each sample image 130 account for the object model 124 perspective. Similarity values are aggregated at each 3D point, e.g., by weighted averaging or max pooling, to handle overlapping projections. The resulting 3D point cloud 126 stores the aggregated values, enabling efficient spatial queries for material similarity across the object model 124.

In at least one example, once the similarity point cloud 126 is generated, the material selector model 208 performs nearest-neighbor lookups to identify regions with similar materials. The nearest-neighbor algorithm efficiently searches the point cloud 126 by partitioning the 3D space into hierarchical structures like k-d trees or octrees, allowing for logarithmic time complexity in finding similar points. To handle different scales of the object model 124 (e.g., different sizes, resolutions), the algorithm normalizes distance metrics based on the overall dimensions of the object model 124, facilitating consistent results regardless of an actual size of the 3D object represented by the object model 124.

This querying process allows for the identification of material parts 128, which represent distinct segments of the object model 124 with similar material properties to the user's selection. These and other aspects of the material selector model 208 are described below with reference to FIG. 2b.

The rendering module 210, which in some cases facilitates the sample image 130 generation, then utilizes the similarity point cloud 126 and the identified material parts 128 to generate a rendered image 132. The rendered image 132 visually represents the results of the material selection 122 and resulting segmentation process, highlighting the selected material parts 128 in relation to other parts of the bicycle object model 124.

The user interface module 204 updates the display device 112 and content of the user interface 110 in response to additional instances of the input 118. The system 200 provides rapid feedback in response to the material selection 122 and resulting segmentation of the object model 124. The system 200 allows the user to iteratively refine the material selection 122,facilitating accurate and desired results applied to editing the object model 124 or generating the output 120, such as the rendered image 132.

The modeling system 200 supports various input modalities and can process multiple types of 3D object representations, including Neural Radiance Fields, three-dimensional Gaussians, and traditional meshes. The material selector model 208 operates on the sample images 130 provided or taken of the object model 124, rather than operate on the object model 124 directly. This approach facilitates compatibility with a range of 3D modeling formats and techniques. The architecture of the material selector model 208 incorporates features such as memory attention mechanisms and multi-view consistency techniques. These techniques enable the model to maintain coherent material selections across different viewpoints by leveraging information from previously processed views and enforcing consistency constraints, addressing challenges in 3D material selection and segmentation by capturing spatial relationships and material properties across the entire object. By leveraging this modeling system 200, the surface appearances of complex 3D objects are editable efficiently, such as changing the material of a bicycle frame from matte to metallic finish, with the system 200 identifying and updating relevant parts of the object model automatically.

The model editor module 206 is configured to handle different types of object models when generating the sample images 130. For Neural Radiance Fields (NeRF) object models, the module renders views by querying the NeRF at different camera positions and integrating radiance along view rays. For 3D Gaussian object models, the model editor module 206 projects the Gaussians to 2D and rasterizes them from multiple viewpoints. For traditional mesh object models, the model editor module 206 applies standard rasterization techniques with the mesh geometry and material properties. This flexibility allows the system to work with various 3D representations while maintaining a consistent pipeline for material selection and segmentation.

The rendering module 210 is capable of applying edits to modify material properties and generate an edited version of the 3D object. After the material parts 128 are identified, the user can input editing parameters to modify properties such as color, roughness, metallic qualities, or texture patterns of the selected materials. The rendering module 210 then updates the material properties of the corresponding regions in the object model 124. For mesh-based objects, this involves modifying shader parameters or texture maps. NeRF or Gaussian-based objects may involve adjusting the learned representations or applying post-processing effects. The rendering module 210 then re-renders the modified 3D object, generating updated sample images that reflect the edited material properties while preserving the overall structure and non-edited parts of the object.

FIG. 2b depicts a block diagram of an example material selector system 214 for processing and analyzing materials in 3D objects, according to aspects of the present disclosure. The material selector system 214 comprises a material selector model 208 that processes inputs from sample images 130 and material selection 122. The material selector model 208 includes several interconnected components arranged in a processing pipeline to enable effective material selection and segmentation. The components work together to analyze visual features, interpret user inputs, maintain consistency across views, and generate accurate material similarity maps.

A training module 230 manages the end-to-end training of the system 214 and individual components within the material selector model 208, facilitating improved performance and adaptability to various input types and 3D object representations. The training module 230 optimizes the input analysis and output generation processes, aiming to ensure that the similarity maps 212, similarity point cloud 126, and material parts 128 accurately represent the material properties and spatial relationships within the 3D object. The training module 230 employs a loss function that measures discrepancies between generated outputs and ground truth data, allowing for iterative refinement of the material selector model 208 parameters. The loss computation takes into account factors such as spatial consistency, material coherence across views, and segmentation accuracy. By minimizing the loss through backpropagation and gradient descent optimization, the training module 230 aims to improve the ability of the material selector model 208 to generate consistent and accurate material selections across diverse 3D objects and viewpoints. The loss function incorporates both pixel-wise and perceptual losses to capture fine-grained details and higher-level semantic information. Additionally, the training module 230 implements techniques such as curriculum learning and data augmentation to enhance the model's generalization capabilities. By carefully balancing various components, the training module 230 aims to produce a robust material selector model 208.

The material selector model 208 includes an image encoder 216. The image encoder 216 processes each sample image 130-n from the set of sample images 130. The image encoder 216 extracts relevant visual features from the input images, capturing information about textures, colors, and spatial relationships within the 3D object. The image encoder 216 utilizes convolutional neural network architectures to efficiently process and compress the visual information from the sample images 130. The image encoder 216 employs multiple convolutional layers with varying filter sizes to capture both fine-grained details and broader contextual information. Skip connections are incorporated to preserve spatial information across different scales of the network. The training module 230 fine-tunes the image encoder 216 using a diverse dataset of 3D objects, enabling the image encoder 216 to generalize across various object types and material properties.

The prompt encoder 220 processes the material selection 122, which may be in the form of text descriptions, user interface selections, or other input modalities. The prompt encoder 220 converts the material selection 122 into a format compatible with the rest of the processing pipeline. The prompt encoder 220 utilizes a transformer-based architecture to handle variable-length input sequences and capture complex relationships between words or selection patterns. The prompt encoder 220 incorporates positional encoding to maintain the order of input elements and employs self-attention mechanisms to weigh the importance of different parts of the input 118. The architecture enables the prompt encoder 220 to effectively process and encode various types of material selection inputs. The transformer-based approach allows for robust handling of both text-based prompts and UI-based selections, providing flexibility in how users can specify material selections across different 3D object types.

The prompt encoder 220 operates under guidance from the training module 230, which helps refine the prompt encoder 220 ability to interpret various types of material selection inputs, ensuring adaptability to different user interaction styles and input formats. The prompt encoder 220 interfaces with the image encoder 216 and memory attention module 218, allowing for integrated processing of visual and textual inputs to generate comprehensive material similarity assessments across the 3D object.

The outputs from the image encoder 216 and prompt encoder 220 are fed into a memory attention module 218. The memory attention module 218 maintains consistency across multiple views of the 3D object by processing the encoded image and prompt information, leveraging attention mechanisms to focus on relevant features and establish relationships between different views of the object. The memory attention module 218 employs a multi-head attention mechanism, allowing different aspects of the input to be attended simultaneously. The memory attention module 218 uses scaled dot-product attention to compute relevance scores between query, key, and value representations derived from the encoded inputs.

The training module 230 optimizes the memory attention module 218 to enhance the memory attention module 218 ability to maintain consistency across diverse viewpoints and object types, improving the overall robustness of the material selection process. The optimization occurs through iterative training on a diverse dataset of 3D objects, where the memory attention module 218 learns to effectively leverage information from previously processed views to inform current predictions, thereby ensuring coherent material selections across multiple perspectives.

The mask decoder 222 takes the output from the memory attention module 218 and generates a similarity map 212-n. The mask decoder 222 interprets the processed information to produce a map indicating the likelihood of material similarity across different regions of the sample image. The mask decoder 222 employs up sampling techniques and skip connections to generate detailed similarity maps that preserve fine-grained spatial information. The mask decoder 222 uses transposed convolutions or sub-pixel convolution layers to increase spatial resolution while maintaining computational efficiency. The mask decoder 222 incorporates residual connections to facilitate gradient flow and enable the generation of high-quality similarity maps.

The training module 230 fine-tunes the mask decoder 222 using a combination of supervised and unsupervised learning techniques, enhancing the mask decoder 222 ability to generate accurate and consistent similarity maps across various 3D object types and viewpoints. The mask decoder 222 works in conjunction with the image encoder 216, prompt encoder 220, and memory attention module 218 to process inputs and generate outputs. The training module 230 optimizes the interactions between these components to improve overall system performance.

The material selector model 208 processes the sample images 130 as a video sequence to maintain temporal consistency. The approach involves constructing a video by inserting each sample image 130 into a sequence of frames. The model then evaluates each subsequent sample image of a subsequent frame based on the previous evaluation of the previous sample image in the sequence. The sequential processing allows the model to leverage temporal information and maintain consistency across different views of the 3D object.

To implement the sequential image processing, the material selector model 208 utilizes a transformer-based architecture, particularly in the memory attention module 218 and memory bank 228. As each sample image 130 is processed, the memory attention module 218 attends to relevant information from previously processed frames stored in the memory bank 228. The approach allows the model to maintain a consistent understanding of the 3D object's materials across different viewpoints.

The material selector model 208 produces three types of outputs: similarity maps 212, which contain the raw similarity values for each processed sample image; a similarity point cloud 126, which represents the aggregated similarity information in 3D space; and material parts 128, which define the segmented regions of similar materials across the entire 3D object. The similarity point cloud 126 is generated using a differentiable point cloud generation module that projects the 2D similarity maps into 3D space based on depth information associated with each sample image. The material parts 128 are obtained through a clustering algorithm applied to the similarity point cloud 126, using techniques such as DBSCAN or mean-shift clustering to group similar regions.

As depicted in FIG. 2b, the material selector model 208 has feedback connections (labeled n-1, n-2, n-3) between components, indicating iterative processing of the sample images 130. The connections enable the system to refine material selection and segmentation results when processing additional views of the 3D object.

The system 214 processes multiple sample images 130 to enhance material selection accuracy. For example, a first sample image 130-1 is analyzed by the image encoder 216. A second sample image 130-2, which may be a duplicate of the first sample image 130-1, is then processed by the image encoder 216, taking into account the memory bank 228 status from the previous analysis of the first sample image 130-1. The process continues for subsequent sample images 130-3 through 130-n, with each iteration benefiting from the accumulated information in the memory bank 228 from prior sample image analyses. The iterative approach allows the system to refine and improve material selection consistency across multiple views of the 3D object and improves the overall accuracy of the material selection process.

In examples, the material selector model 208 employs a frame duplication technique to enhance consistency in material selection across multiple views. This approach involves generating a video sequence from the sample images 130, with the first frame corresponding to a first sample image 130-1, which is duplicated multiple times at the beginning of the sequence. By duplicating the first frame, the material selector model 208 establishes a strong initial reference for material properties, allowing the material selector model 208 to build a more robust understanding of the object model 124 materials from the outset. This technique is particularly effective when processing complex 3D objects with varying viewpoints, as the material selector model 208 has additional time to analyze and establish baseline material characteristics before encountering substantial changes in perspective or lighting conditions. The frame duplication process is seamlessly integrated into the video sequence construction, enabling the material selector model 208 to leverage temporal consistency techniques adapted from video segmentation models without requiring additional pre-processing steps. This approach contributes to the material selector model 208 ability to maintain consistent material selections across different viewpoints and object types, addressing challenges in 3D material selection and segmentation by capturing spatial relationships and material properties more effectively across the entire object. The frame duplication technique can improve processing efficiency by reducing the number of iterations for achieving consistent material selections. By providing a stronger initial reference, the model may converge on accurate selections more quickly, potentially reducing overall computation time.

The feedback connections implement a form of recurrent processing, allowing information from previous iterations to influence current predictions. The recurrent structure is trained using backpropagation through time (BPTT) to optimize the model's ability to maintain consistency across long sequences of views. The training module 230 fine-tunes the feedback connections, facilitating that the system 214 effectively leverages information from multiple viewpoints to improve material selection accuracy and consistency.

The material selector model 208 is adapted from a video segmentation model and fine-tuned on a custom dataset of rendered videos. The adaptation allows the model to leverage techniques developed for maintaining temporal consistency in video processing, which are well-suited for handling multiple views of 3D objects. The fine-tuning process on rendered videos helps the model learn to handle the specific challenges associated with material selection in 3D environments, such as varying lighting conditions and complex surface geometries. The adaptation process involves modifying the input and output layers of the video segmentation model to handle the specific requirements of material selection. The fine-tuning dataset includes a diverse range of 3D objects with varying materials, lighting conditions, and camera movements to ensure robust performance across different scenarios. The training module 230 manages the adaptation and fine-tuning process, implementing curriculum learning strategies to gradually increase the complexity of the training data and optimize the model's performance on material selection tasks.

The architecture of the material selector model 208 enables efficient and accurate material selection and segmentation across various types of 3D objects. By processing multiple sample images 130 and maintaining consistency through memory mechanisms, the system can handle complex geometries and varying viewpoints. The approach provides robust support for claims related to multi-view consistency, temporal processing of 3D objects, and adaptive material selection techniques. The model's ability to generalize across different 3D representations, such as meshes, point clouds, and volumetric data, is enhanced by the use of a shared feature extraction backbone followed by representation-specific processing modules. The modular design allows for easy adaptation to new 3D formats while maintaining the core material selection capabilities.

The image encoder 216 processes each sample image 130 in the sequence, extracting relevant features. The features are then passed to the memory attention module 218, which compares the features with the information stored in the memory bank 228 from previous frames. The comparison helps the model identify consistent material properties across different views and update the understanding of the 3D object's materials. The mask decoder 222 generates similarity maps 212 for each frame, taking into account both the current frame's features and the accumulated information from previous frames. The approach ensures that the generated similarity maps are consistent across the entire sequence of sample images.

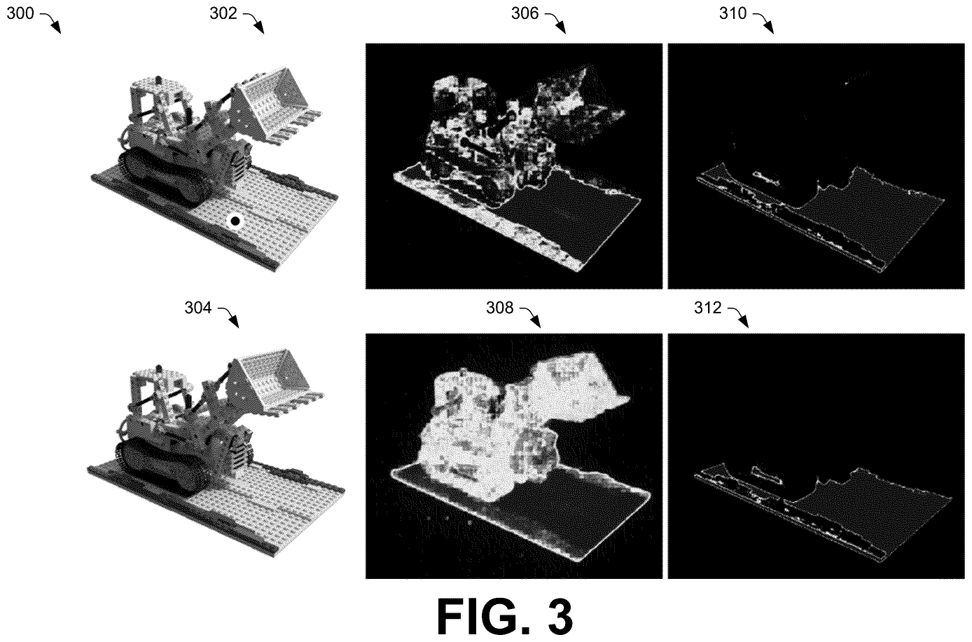

FIG. 3 illustrates example results 300 from an example material selector model in response to using different material selection modalities, according to aspects of the present disclosure. The results 300 demonstrate the material selection and segmentation techniques implemented by the material selector model 208. The top row of the results 300 corresponds to a material selection 302 that designates a specific part of the object model 124, in this case, a toy brick bulldozer. The bottom row represents predictions from the material selector model 208 trained on image data only, demonstrating improved prediction on unclicked frames when finetuned on videos.

In response to the material selection 302 in the top row, the material selector model 208 generates a similarity point cloud 306 and isolates the material part 310 designated by the selection. Although depicted as black and white or grayscale heat map representations for simplicity and ease of duplication of the drawings, the material selector model 208 visualizes both the similarity point cloud 306 and the material part 310 using color or grayscale heat map representations, where color, shade, and/or pixel intensity indicates degrees of similarity to the selected material. Similarly, in the bottom row, the material selector model 208 processes the unclicked frame to produce a similarity point cloud 308 and isolate the material part 312. The material selector model 208 also visualizes these using color or grayscale heat map representations, mirroring the approach used in the top row. The use of grayscale instead of colormaps may impact the visualization of selections, potentially making subtle differences in material similarity less apparent.

The material selector model 208 derives these similarity maps through a series of operations. The material selector model 208 begins by extracting visual features from a sample input image, including color, texture, and local patterns. The material selector model 208 then compares these extracted features to the characteristics of the selected area using convolutional neural network layers. This comparison yields per-pixel similarity scores, which are subsequently normalized to create comparable values. The material selector model 208 refines these scores by considering spatial relationships and global context, resulting in heat maps where warmer colors (e.g., red) indicate higher similarity to the selected material, while cooler colors (e.g., blue) signify lower similarity.

The results 300 convey the versatility of the material selector model 208 in handling different input modalities by presenting both UI selection and prompt selection examples as part of the results 300. This demonstration is an example of the capability of the material selector model 208 to process and analyze material selections regardless of whether the material selections originate from direct user interface interactions or text-based descriptions, highlighting flexibility and robustness in various modeling scenarios.

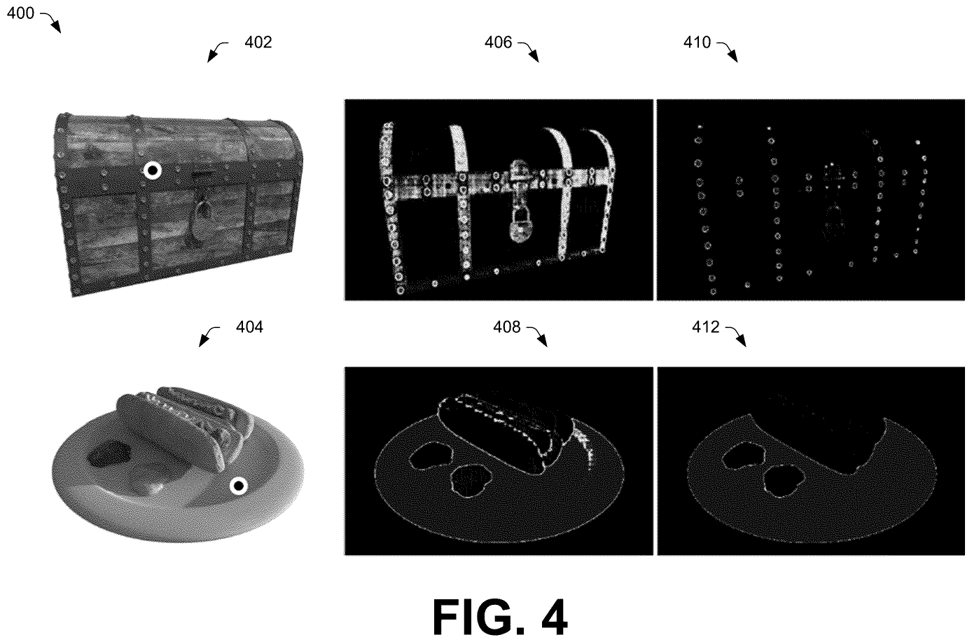

As emphasized by the results 300, FIG. 3 demonstrates the versatility of the material selector model 208 in interpreting various selection types, showing side-by-side comparisons of similarity point clouds and material parts for each selection method. While FIG. 3 focuses on demonstrating the material selector model 208 ability to handle different input modalities (UI-based and text-based selections) for a single object, FIG. 4 illustrates the progression of material selection processing across multiple objects and views.

FIG. 4 demonstrates additional example results 400 from an example material selector model based on duplicating sample images, according to aspects of the present disclosure. The results 400 convey a series of views showing material selection processing for the same viewpoint of a 3D object, illustrating the effects of using frame duplication.

In the top row, a material selection 402 is shown as a 2D view of a 3D rendered object. Adjacent to the material selection 402, a similarity map 406 displays the material analysis as a color or grayscale heatmap representation (e.g., heatmap image) predicted by the trained model without using frame duplication. To the right, a material part 410 (e.g., heatmap image) shows the distribution of similarity values in two-dimensional space after applying frame duplication.

The bottom row presents another material selection 404 rendered in 2D view. Next to the material selection 404, a similarity map 408 displays the analyzed material regions without using frame duplication. The rightmost image shows a material part 412 representing the processed material selection output using frame duplication.

FIG. 4 depicts the progression of material selection processing for the same object and viewpoint, showing the transformation from initial 2D views through similarity analysis to final selection outputs. The arrangement allows comparison between the original views and their corresponding processed representations, illustrating how frame duplication affects the material selection process.

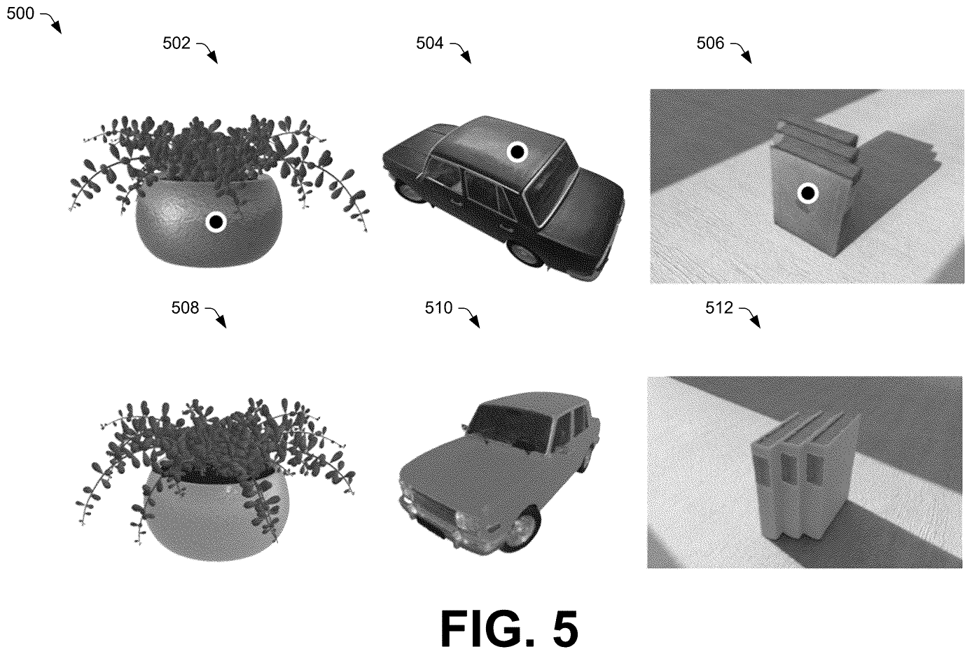

FIG. 5 shows example results 500 from an example material selector model in response to complex object model inputs, according to aspects of the present disclosure. The results 500 demonstrate the material selection and segmentation capabilities of the material selector model 208 across various types of 3D object models, including Neural Radiance Fields, 3D Gaussians, and meshes. FIG. 5 is arranged in two rows, with the top row displaying original 3D models as examples of the object model 124 and the bottom row showing corresponding similarity point cloud representations as examples of the similarity point cloud 126.

In the top row, three distinct 3D models are presented: a planter model 502 with decorative foliage, a vehicle model 504 depicting a sedan-style automobile, and a books model 506 showing a stack of books. Each model is rendered from a perspective view to highlight depth and dimensionality, representing different types of 3D object models. The planter model 502 exemplifies a Neural Radiance Field representation, the vehicle model 504 demonstrates a 3D Gaussian model, and the books model 506 illustrates a traditional mesh-based model. In the top row, three distinct 3D models are presented: a planter model 502 with decorative foliage, a vehicle model 504 depicting a sedan-style automobile, and a books model 506 showing a stack of books. Each model is rendered from a perspective view to highlight depth and dimensionality, representing different types of 3D object models. The planter model 502 exemplifies a Neural Radiance Field representation, the vehicle model 504 demonstrates a 3D Gaussian model, and the books model 506 illustrates a traditional mesh-based model.

The bottom row presents the corresponding similarity point cloud representations for each model. Similarity point cloud 508 corresponds to the planter model 502, displaying the material similarity analysis results for the Neural Radiance Field representation. Similarity point cloud 510 shows the processed representation of the vehicle model 504, maintaining the vehicle's form while representing material similarities in the 3D Gaussian model. Similarity point cloud 512 presents the material similarity analysis of the books model 506, preserving the geometric structure of the mesh-based model while indicating material properties. The bottom row presents the corresponding similarity point cloud representations for each model. Similarity point cloud 508 corresponds to the planter model 502, displaying the material similarity analysis results for the Neural Radiance Field representation. Similarity point cloud 510 shows the processed representation of the vehicle model 504, maintaining the vehicle's form while representing material similarities in the 3D Gaussian model. Similarity point cloud 512 presents the material similarity analysis of the books model 506, preserving the geometric structure of the mesh-based model while indicating material properties.

Each similarity point cloud representation uses color-coded values to indicate areas of similar materials, with the point clouds maintaining the three-dimensional form of their corresponding original models. The color intensity in the similarity point clouds represents the degree of similarity to the selected material, with warmer colors indicating higher similarity and cooler colors signifying lower similarity. This visualization technique allows for intuitive interpretation of material similarities across the complex geometries of the 3D objects. Each similarity point cloud representation uses color-coded values to indicate areas of similar materials, with the point clouds maintaining the three-dimensional form of corresponding original models. The color intensity in the similarity point clouds represents the degree of similarity to the selected material, with warmer colors indicating higher similarity and cooler colors signifying lower similarity. This visualization technique allows for intuitive interpretation of material similarities across the complex geometries of the 3D objects.

The material selector model 208 processes these diverse 3D object types by adapting its analysis techniques to the specific characteristics of each representation. For Neural Radiance Fields, the model analyzes the learned radiance and density functions to identify material similarities. In processing 3D Gaussian models, the material selector model 208 examines the distribution and properties of the Gaussian primitives to determine material relationships. For mesh-based models, the system analyzes surface properties, textures, and geometric features to identify similar materials. The material selector model 208 processes these diverse 3D object types by adapting analysis techniques to the specific characteristics of each representation. For Neural Radiance Fields, the model analyzes the learned radiance and density functions to identify material similarities. In processing 3D Gaussian models, the material selector model 208 examines the distribution and properties of the Gaussian primitives to determine material relationships. For mesh-based models, the system analyzes surface properties, textures, and geometric features to identify similar materials.

The results 500 in FIG. 5 demonstrate the versatility of the material selector model 208 in handling various types of 3D object representations. By successfully processing and analyzing Neural Radiance Fields, 3D Gaussians, and meshes, the system highlights adaptability to different 3D modeling techniques. This capability enables the material selection and segmentation system to work effectively across a wide range of 3D content creation workflows and applications. The results 500 in FIG. 5 demonstrate the versatility of the material selector model 208 in handling various types of 3D object representations. By successfully processing and analyzing Neural Radiance Fields, 3D Gaussians, and meshes, the system highlights adaptability to different 3D modeling techniques. This capability enables the material selection and segmentation system to work effectively across a wide range of 3D content creation workflows and applications.

The similarity point clouds 508, 510, and 512 serve as the basis for generating rendered images that visually represent the material selection and segmentation results. These rendered images, produced by the rendering module 210, highlight the selected materials on the 3D objects, providing clear visual feedback on the material selection process. The rendering module 210 utilizes the information from the similarity point clouds to create detailed, visually informative representations of the material selections, enhancing user understanding and facilitating further editing or analysis of the 3D objects. The similarity point clouds 508, 510, and 512 serve as the basis for generating rendered images that visually represent the material selection and segmentation results. These rendered images, produced by the rendering module 210, highlight the selected materials on the 3D objects, providing clear visual feedback on the material selection process. The rendering module 210 utilizes the information from the similarity point clouds to create detailed, visually informative representations of the material selections, enhancing user understanding and facilitating further editing or analysis of the 3D objects.

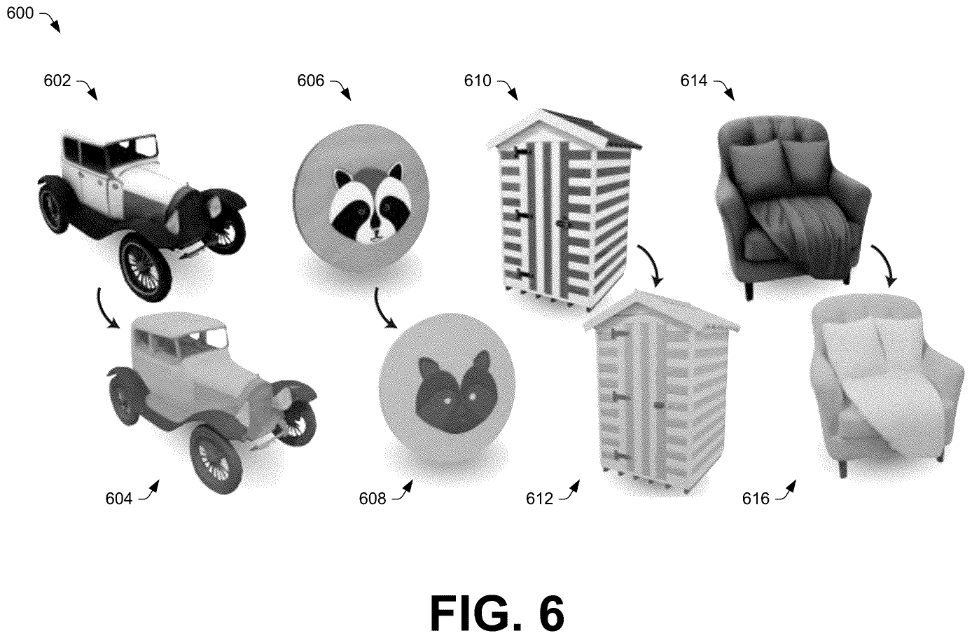

FIG. 6 depicts additional example results 600 from an example material selector model in response to complex mesh inputs, according to aspects of the present disclosure. The results 600 show pairs of images demonstrating the material selection and editing capabilities of the modeling tool 116 and the material selector model 208. Each pair includes an original 3D mesh model above a corresponding edited version with modified material properties. For example, object model 602 depicts a vintage car with original brown/beige coloration, while edited object model 604 segments and designates similar material parts with a corresponding color (e.g., parts of the body are shaded one color, and the tires and accent pieces are shaded with different colors). The color is applied to the edited object model 604 to indicate feedback of which parts are being edited. The edited object model 604 visualizes material variation, independent of colors or shading designated by the object model 602. Object model 606 shows a circular raccoon face coin, with edited object model 608 displaying the same raccoon in different colors to distinguish the racoon face material with the unpainted finish of the rest of the coin. Object model 610 depicts a striped beach hut structure transformed to edited object model 612. Object model 614 represents an armchair, which transitions from an original color scheme to a material based color scheme in edited object model 616 to convey similar fabric material parts contrasted with material parts that encompass the legs. This visualization effectively demonstrates how the material selector model 208 enables users to select specific materials on complex 3D mesh objects and apply edits to those selected regions while maintaining the overall structure and geometry of the model.

FIG. 7 illustrates a flowchart of a process 700 for training an example material selector model, according to aspects of the present disclosure. For ease of description, the process 700 is described in the context of the environment 100 when implemented by the computing device 102, the content processing system 104, and the modeling tool 116 for training the material selector model 208. The training module 230 directs the process 700 to train the material selector model 208 in at least one example.

The process 700 begins at block 702, where training sample images of three-dimensional objects and material selections designating material parts of the three-dimensional objects are received. The training module 230, for instance, collects a diverse dataset of 3D objects, such as those shown in FIG. 5 (e.g., planter model 502, a vehicle model 504, and a books model 506), along with corresponding material selections. These material selections may be similar to those demonstrated in FIG. 3 and FIG. 4, where specific parts of the objects are designated for material analysis.

The process 700 then proceeds to block 704, where the training sample images, and material selections are input as training inputs to a material selector model that generates training similarity maps indicating material similarity across the three-dimensional objects. For example, the material selector model 208 processes the input 118 to produce similarity maps 212 similar to those shown in FIG. 3 and FIG. 4. The training module 230 directs this process in variations to check whether the material selector model 208 correctly interprets the input 118 and generates appropriate similarity maps 212.

In variations, the material selector model 208 is trained using only 2D data, specifically images and video frames, without explicit 3D data or point clouds. This 2D training approach results in consistent predictions across different 2D views, effectively providing 3D point cloud representations as a byproduct. The training process involves exposing the model to diverse 2D representations of 3D objects from various angles and under different lighting conditions. By learning to recognize material properties and similarities in these 2D projections, the model develops the ability to make consistent predictions across multiple views of the same 3D object. In example implementations where applied, this 2D-only training approach allows the system to handle various 3D object representations without requiring explicit 3D training data. The consistency in predictions across different 2D views enables the system to effectively perform material selection and segmentation in 3D space, despite operating solely on 2D inputs during both training and inference.

Following block 704, the process 700 moves to block 706, where example similarity point clouds are generated based on the training similarity maps output from the material selector model. The training module 230 directs the material selector model 208 to output the 2D similarity maps as 3D point clouds, similar to those depicted in FIG. 5 (similarity point clouds 508, 510, and 512). The training module 230 guides the transformation process, ensuring that the resulting point clouds accurately represent the material similarities in three-dimensional space.

The process 700 then advances to block 708, where parameters of the material selector model are adjusted based on comparisons between the example similarity point clouds and ground truth material segmentations to reduce differences between them. The training module 230 may implement a loss function to measure discrepancies between the generated point clouds and known correct segmentations. The training module 230 uses techniques such as backpropagation to adjust the parameters of the material selector model 208, aiming to reduce or eliminate discrepancies.

The process 700 concludes at block 710, where the trained material selector model is configured to output material parts based on a similarity point cloud created based on similarity maps generated from a plurality of sample images of a three-dimensional object and a material selection. The training module 230 prepares the material selector model 208 for deployment in real-world applications, such as those demonstrated in FIG. 6, where the modeling tool 116 is used to process complex mesh inputs and generate accurate material selections and edits.

Throughout the training process, the material selector model 208 may be adapted from a video segmentation model and fine-tuned on a dataset of rendered videos with pre-assigned materials. The training module 230 controls adaptation and fine-tuning of the training process, implementing curriculum learning strategies to gradually increase the complexity of the training data and optimize the material selector model 208 performance on material selection tasks. The fine-tuning process includes, for example, sampling multiple (e.g., 6) consecutive frames from a random starting point in each video, sampling “clicks” on a specific material of each other frame and querying the model on each frame to encourage use of memory embedding. This approach allows the material selector model 208 to leverage techniques developed for maintaining temporal consistency in video processing, which are well-suited for handling multiple views of 3D objects.

FIG. 8 illustrates a flowchart of a process 800 for material selection and segmentation of 3D objects, according to aspects of the present disclosure. The process 800 includes several blocks that demonstrate the workflow for analyzing and selecting materials in 3D models. In various examples, the process 800 is performed by the computing device 102, the content processing system 104, the modeling tool 116, and so forth, after the process 700 for training the material selector model 208 occurs.

The process 800 starts at block 802, which outputs a user interface that previews an object model. For example, the user interface module 204 of the modeling tool 116 generates a preview of the object model 124 and displays the preview on the user interface 110 presented by the display device 112. In variations, the preview resembles the 3D models shown in FIG. 5, such as the planter model 502 or vehicle model 504.

The process 800 then proceeds to block 804, where a material selection that designates a material part of the object model is received. For example, the user interface module 204 accepts input 118 in the form of a material selection 122, which is a prompt selection 122-1 or a UI selection 122-2, as depicted in FIG. 1. The material selection 122 may be similar to each demonstrated in FIG. 3, where specific parts of objects are designated for material analysis. To enhance flexibility and user interaction, the user interface module 204 is capable of converting UI selections into prompt selections. When a user makes a UI selection 122-2 by interacting with the object model 124 displayed in the user interface 110, such as clicking on the frame of a bicycle model, the user interface module 204 translates this visual selection into a text-based prompt selection 122-1. For instance, it may generate a prompt like “select metallic frame material.” This conversion enables the system to process both direct visual selections and text-based prompts uniformly, enhancing flexibility and user interaction options.

At block 806, the process 800 obtains a plurality of sample images showing different views of the object model and the material part designated by the material selection. The model editor module 206 may generate the sample images 130 by rendering different views of the object model 124, similar to how multiple perspectives are shown in FIG. 2a, and in FIG. 4 for material selections 402 and 404.

Continuing to block 808, the process 800 inputs the sample images and the material selection into a material selector model that creates a similarity point cloud enabling material similarity querying across multiple material parts of the object model. The material selector model 208, for example, is configured to process the sample images 130 and material selection 122 using advanced machine learning techniques. These techniques utilize one or more convolutional neural networks and transformer architectures to extract relevant features for material similarity analysis. The model processes the inputs to generate similarity maps 212, which are then used to create the similarity point cloud 126.

The material selector model 208 derives the similarity maps by first extracting visual features from each sample image, including color, texture, and local patterns. The material selector model 208 then compares these extracted visual features to characteristics of the selected area using convolutional neural network layers. Based on this comparison, the material selector model 208 generates per-pixel similarity scores, which are subsequently normalized. The material selector model 208 further refines these scores by considering spatial relationships and global context, resulting in comprehensive similarity maps 212 that capture nuanced material properties across different perspectives of the 3D object.

The similarity point cloud 126 allows for efficient querying of material similarities, as demonstrated by the point cloud representations in FIG. 5 (similarity point clouds 508, 510, and 512). To identify regions with similar materials, the material selector model 208 performs nearest-neighbor lookups by querying the similarity point cloud 126. This process involves partitioning the 3D space of the similarity point cloud 126 into hierarchical structures, such as k-d trees or octrees. The material selector model 208 then normalizes distance metrics based on the overall dimensions of the object model 124 to ensure consistent results regardless of the object's actual size. Using these optimized structures, the material selector model 208 efficiently searches the partitioned space to find similar points with logarithmic time complexity.

To maintain temporal consistency and leverage information across multiple views, the material selector model 208 processes the sample images as a video sequence. A video is constructed by inserting each of the sample images 130 into a sequence of frames. The material selector model 208 then evaluates each subsequent sample image 130 of a subsequent frame based on the previous evaluation of a previous sample image in the sequence. This approach allows the material selector model 208 to build a more comprehensive understanding of the 3D object's materials by aggregating information from multiple perspectives over time, similar to how a person might examine an object from different angles to fully understand its material properties.

In this example, the process 800 ends with block 810, where, via the user interface, an indication of different material parts of the object model that have a similar material as the material part designated by the material selection is presented. The rendering module 210 generates a rendered image 132 highlighting the identified material parts 128, which is then displayed on the user interface 110. This visualization allows users to see which regions of the 3D object share similar material properties to the selected area. The rendering module 210 processes the analyzed data, including the similarity point cloud 126 and identified material parts 128, to produce a rendered image 132. This image modifies the user interface by previewing the different material parts of the object model that have a similar material as the part designated by the material selection. To create this rendered image, the rendering module 210 obtains coordinates of the different material parts from the similarity point cloud 126. These coordinates correspond to regions identified as having similar materials to the designated part. The rendering module 210 then uses these coordinates to highlight or emphasize the relevant parts in the rendered image. This visual representation may use color coding, transparency effects, or other graphical techniques to clearly indicate the selected material regions on the 3D object. The rendered image 132 is then presented in the user interface 110 as a clear indication of the different material parts of the object model that share similar material properties with the part designated by the user's selection. This visual feedback allows users to quickly understand and verify the results of their material selection, facilitating an intuitive and interactive material editing process.

Throughout the process 800, the training module 230 may continuously refine the material selector model 208 to enhance accuracy in identifying and segmenting materials across various types of 3D objects and viewpoints. The process 800 demonstrates how the system 200 handles material selection and segmentation tasks for complex 3D models, providing users with tools for analyzing and editing material properties in three-dimensional space.

FIG. 9 illustrates a flowchart depicting an algorithm as a step-by-step process 900 for training a machine-learning model according to aspects of the present disclosure. In some examples, the process 900 describes an operation of the training module 230 described for configuring the material selector model 208, e.g., as described with reference to FIG. 2b. The process 900 provides one or more examples of generating training data, use of the training data to train a machine-learning model, and use of the trained machine-learning model to perform a task.

To begin in this example, a machine-learning system collects training data (block 902) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 904) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 906). Initialization of the machine-learning model includes selecting a model architecture (block 908) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 910). The loss function is utilized to measure a difference between an output of the machine-learning model (i.e., predictions) and target values (e.g., as expressed by the training data) to be used to train the machine-learning model. Additionally, an optimization algorithm is selected (block 912) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 916) examples of which includes initializing weights and biases of nodes to improve efficiency in training and computational resources consumption as part of training. Hyperparameters are also set (block 914) that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 918) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 920), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 920), the process 900 continues training of the machine-learning model using the training data (block 918) in this example.

If the stopping criterion is met (“yes” from decision block 920), the trained machine-learning model is then utilized to generate an output based on subsequent data (block 922). The trained machine-learning model, for instance, is trained to perform a task as described above and therefore once trained is configured to perform that task based on subsequent data received as an input and processed by the machine-learning model.

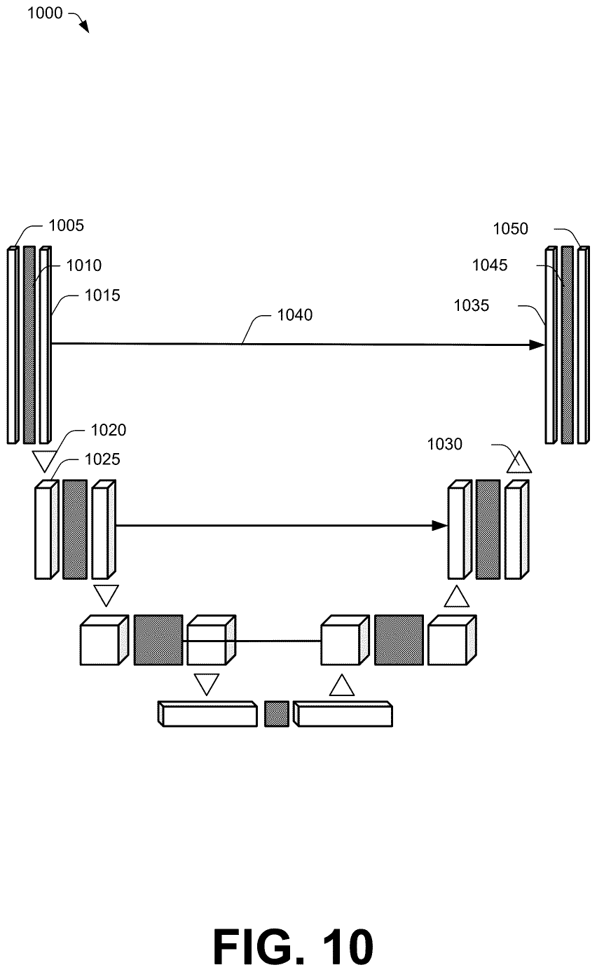

FIG. 10 illustrates an example of a U-Net 1000 according to aspects of the present disclosure. In some examples, the U-Net 1000 is an example architecture of at least part of the material selector model 208 depicted in FIG. 2b.

In some examples, diffusion models are based on a neural network architecture known as a U-Net. The U-Net 1000 takes input features 1005 having an initial resolution and an initial number of channels and processes the input features 1005 using an initial neural network layer 1010 (e.g., a convolutional network layer) to produce intermediate features 1015. The intermediate features 1015 are then down-sampled using a down-sampling layer 1020 such that down-sampled features 1025 features have a resolution less than the initial resolution and a number of channels greater than the initial number of channels.

This process is repeated multiple times, and then the process is reversed. That is, the down-sampled features 1025 are up-sampled using up-sampling process 1030 to obtain up-sampled features 1035. The up-sampled features 1035 can be combined with intermediate features 1015 having the same resolution and number of channels via a skip connection 1040. These inputs are processed using a final neural network layer 1045 to produce output features 1050. In some cases, the output features 1050 have the same resolution as the initial resolution and the same number of channels as the initial number of channels.

In some cases, U-Net 1000 takes additional input features to produce conditionally generated output. For example, the additional input features could include a vector representation of an input prompt. The additional input features can be combined with the intermediate features 1015 within the neural network at one or more layers. For example, a cross-attention module can be used to combine the additional input features and the intermediate features 1015.

### Example System and Device

FIG. 11 illustrates an example system 1100 including various components of an example device usable as any type of computing device as described and/or utilized with reference to FIGS.
1-10 to implement examples of the techniques described herein. FIG. 11 illustrates an example system 1100 generally, which includes an example computing device 1102 that is representative of one or more computing systems and/or devices that implement the various techniques described herein. This is illustrated through inclusion of the modeling tool 116. The computing device 1102 is configurable, for instance, as a server of a service provider, a device associated with a client (e.g., a client device), an on-chip system, and/or any other suitable computing device or computing system.

The example computing device 1102 as illustrated includes a processing system 1104, one or more computer-readable media 1106, and one or more I/O interface 1108 that are communicatively coupled, one to another. Although not shown, the computing device 1102 further includes a system bus or other data and command transfer system that couples the various components, one to another. In one or more examples, a system bus includes any one, or combination, of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1104 is representative of functionality to perform one or more operations using hardware. Accordingly, the processing system 1104 is illustrated as including the hardware elements 1110, which are configurable as processors, functional blocks, and so forth. This includes implementation in hardware as an application specific integrated circuit or other logic device formed using one or more semiconductors. The hardware elements 1110 are not limited by the materials that form the hardware elements 1110, or the processing mechanisms employed therein. For example, processors are configurable as semiconductor(s) and/or transistors, e.g., electronic integrated circuits (ICs). In such a context, processor-executable instructions are electronically executable instructions.

The computer-readable media 1106 is storage media illustrated as including memory/storage 1112. The memory/storage 1112 represents memory/storage capacity associated with one or more computer-readable media. The memory/storage 1112 is configured as a memory component, for example, which is configured to store the digital content 106. The memory/storage 1112 includes volatile media (such as random access memory (RAM)) and/or nonvolatile media, such as read-only memory (ROM), Flash memory, optical disks, magnetic disks, and so forth. The memory/storage 1112 includes fixed media (e.g., RAM, ROM, a fixed hard drive, and so on) as well as removable media, e.g., Flash memory, a removable hard drive, an optical disc, and so forth. The computer-readable media 1106 is configurable in a variety of other ways as further described below.

Input/output interface(s) 1108 are representative of functionality to allow a user to enter commands and information to computing device 1102, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1102 is configurable in a variety of ways to support user interaction, as described herein.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms and for a variety of processors.

An implementation of the described modules and techniques is stored on or transmitted across some form of computer-readable media. The computer-readable media includes a variety of media that is accessed by the computing device 1102. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable, and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer. “Computer-readable signal media” refers to a signal-bearing medium that is configured to transmit instructions to the hardware of the computing device 1102, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of signal characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1110 and computer-readable media 1106 are representative of modules, programmable device logic and/or fixed device logic implemented in a hardware form that are employed in some examples to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously. For example, the hardware elements 1110 include a processing device coupled to the memory component implemented by the memory/storage 1112 to perform operations of the modeling tool 116. The operations, when executed, cause the processing device implemented by the hardware elements 1110 to render a scene using the digital content 106 stored in the memory/storage 1112.

Combinations of the foregoing are also employed to implement various techniques described herein. Accordingly, software, hardware, or executable modules are implemented as one or more instructions and/or logic embodied on some form of computer-readable storage media and/or by one or more hardware elements 1110. The computing device 1102 is configured to implement particular instructions and/or functions corresponding to the software and/or hardware modules. Accordingly, implementation of a module that is executable by the computing device 1102 as software is achieved at least partially in hardware, e.g., through use of computer-readable storage media and/or hardware elements 1110 of the processing system 1104. The instructions and/or functions are executable/operable by one or more articles of manufacture (e.g., at least one computing device 1102 and/or processing systems 1104) to implement techniques, modules, and examples described herein.

The techniques described herein are supported by various configurations of the computing device 1102 and are not limited to the specific examples of the techniques described herein. This functionality is also implementable or partially implementable through use of a distributed system, such as over a “cloud” 1114 via a platform 1116 as described below.

The cloud 1114 includes and/or is representative of a platform 1116 for resources 1118. The platform 1116 abstracts underlying functionality of hardware (e.g., servers) and software resources of the cloud 1114. The resources 1118 include applications and/or data utilized while computer processing is executed on servers that are remote from the computing device 1102. In at least one example, the resources 1118 include services provided over the Internet and/or through a subscriber network, such as a cellular or Wi-Fi network.

The platform 1116 abstracts resources and functions to connect the computing device 1102 with other computing devices. The platform 1116 also serves to abstract scaling of resources to provide a corresponding level of scale to encountered demand for the resources 1118 that are implemented via the platform 1116. Accordingly, in an interconnected device example, implementation of functionality described herein is distributable throughout the system 1100. The functionality is implementable in part on the computing device 1102 as well as via the platform 1116 that abstracts the functionality of the cloud 1114.

Although the techniques have been described in language specific to structural features and/or methodological acts, it is to be understood that the techniques defined in the appended claims are not limited to the specific features or acts described. Rather, the specific features and acts are disclosed as example forms of implementing the claims.

What is claimed is:

1. A method comprising:
outputting, by a processing device, a user interface that previews an object model;
receiving, by the processing device, a material selection that designates a material part of the object model;
obtaining, by the processing device, a plurality of sample images showing different views of the object model and the material part designated by the material selection;
inputting, by the processing device, the sample images and the material selection into a material selector model that creates a similarity point cloud enabling material similarity querying across multiple material parts of the object model; and
presenting, by the processing device via the user interface, an indication of different material parts of the object model that have a similar material as the material part designated by the material selection.

2. The method of claim 1, wherein the inputting includes:
applying machine learning of the material selector model by deriving a similarity map corresponding to each sample image indicating material similarities across the different material parts of the object model and the material part designated by the material selection.

3. The method of claim 2, wherein the similarity map corresponding to each sample image includes a heat map image that uses pixel color and intensity variation to indicate different degrees of similarity between the material part designated by the material selection and the different material parts of the object model.

4. The method of claim 1, the presenting including:
outputting a rendered image of the indication at a display device that modifies the user interface by previewing the different material parts of the object model that have the similar material as the material part designated by the material selection.

5. The method of claim 4, the presenting including:
obtaining, from the similarity point cloud, coordinates of the different material parts of the object model that have the similar material as the material part designated by the material selection; and
presenting the rendered image in the user interface as the indication of the different material parts of the object model that have the similar material as the material part designated by the material selection.

6. The method of claim 1, wherein the material selection comprises at least one of a prompt selection describing a specific material that designates the material part of the object model, or a user interface selection that designates the material part of the object model.

7. The method of claim 6, further comprising:
converting, by the processing device, a user interface selection received at the user interface that designates the material part of the object model into the prompt selection describing the specific material that designates the material part of the object model.

8. The method of claim 1, further comprising:
performing, by the processing device, a nearest-neighbor lookup of the different material parts of the object model by querying the similarity point cloud and determining the different material parts of the object model that have the similar material as the material part designated by the material selection.

9. The method of claim 1, wherein the inputting includes:
constructing, by the processing device, a video by inserting each of the sample images into a sequence of frames;
causing, by the processing device, the material selector model to receive the sample images by receiving the video; and
evaluating each subsequent sample image of a subsequent frame in the video sequence based on a previous evaluation of a previous sample image of a previous frame in the sequence.

10. A method comprising:
receiving, by a processing device, a plurality of training sample images of three dimensional objects and material selections designating material parts of the three dimensional objects;
inputting, by the processing device, the training sample images and the material selections as training inputs to a material selector model that generates training similarity maps indicating material similarity across the three dimensional objects;
generating, by the processing device, example similarity point clouds created based on the training similarity maps output from the material selector model;
adjusting, by the processing device, parameters of the material selector model based on comparisons between the example similarity point clouds and ground truth material segmentations that reduce differences between the example similarity point clouds and the ground truth material segmentations; and
configuring the trained material selector model to output material parts based on a similarity point cloud created based on similarity maps generated from a plurality of sample images of a three dimensional object and a material selection.

11. The method of claim 10, further comprising:
generating, by the processing device, the training similarity maps by applying the material selector model to each training sample image;
producing, by the processing device, a per-pixel similarity score for each pixel in each training sample image; and
aggregating, by the processing device, the per-pixel similarity scores across multiple views of a same three dimensional object to create a multi-view consistent similarity map.

12. The method of claim 10, the generating includes:
creating the example similarity point clouds by:
back-projecting the training similarity maps into three dimensional space using depth information associated with each training sample image;
aggregating similarity values from multiple views at each three dimensional point; and
storing the aggregated similarity values in a three dimensional data structure enabling spatial queries.

13. The method of claim 10, wherein the adjusting includes:
computing a loss function that measures discrepancies between the training similarity maps and the ground truth material segmentations;
backpropagating the loss through the material selector model; and
updating model weights using a gradient descent optimization algorithm.

14. The method of claim 10, further comprising:
outputting, by the processing device, a rendered image of the material parts identified differently from other material parts captured by the similarity point cloud.

15. A system comprising:
a memory component; and
one or more processing devices coupled to the memory component, the processing devices operable to:
receive a plurality of sample images of a three dimensional object and a material selection designating a material part of the three dimensional object;
process the sample images and the material selection using a material selector model that generates similarity maps indicating material similarity across the three dimensional object used in creating a similarity point cloud;
output a material part based on the similarity point cloud; and
present, via a user interface, an indication of different material parts of the three dimensional object that have a similar material as a material part designated by the material selection.

16. The system of claim 15, wherein the material selector model is configured to process the sample images as a video sequence, and the processing devices are further operable to:
construct a video by inserting each of the sample images into a sequence of frames;
cause the material selector model to receive the sample images by receiving the video; and
evaluate each subsequent sample image of a subsequent frame in the video sequence based on a previous evaluation of a previous sample image of a previous frame in the sequence.

17. The system of claim 15, wherein the processing devices are further operable to:
convert a user interface selection received at the user interface that designates the material part of the three dimensional object into a prompt selection describing a specific material that designates the material part of the three dimensional object.

18. The system of claim 15, wherein the processing devices are further operable to:
output a rendered image of the indication at a display device that modifies the user interface by previewing the different material parts of the three dimensional object that have the similar material as the material part designated by the material selection.

19. The system of claim 15, wherein the material selector model is configured to generate the sample images of the three dimensional object by generating different views of an object model describing the three dimensional object including at least one of Neural Radiance Fields object model, three dimensional Gaussian object model, and mesh object model.

20. The system of claim 15, wherein the processing devices are further operable to:
receive an editing input for modifying material properties of the material parts;
apply the editing input to modify the material properties of the material parts in the three dimensional object; and
generate an edited version of the three dimensional object with the modified material properties.
